(19) United States
(12) Patent Application Publication
(10) Pub. No.: US 2015/0211292 A1
(43) Pub. Date: Jul. 30, 2015

(54) WINDOW BLIND

(71) Applicant: NIEN MADE ENTERPRISE CO., LTD., Taichung City (TW)

(72) Inventor: CHIH-YAO CHANG, Taichung (TW)

(21) Appl. No.: 14/603,510

(22) Filed: Jan. 23, 2015

(30) Foreign Application Priority Data
Jan. 24, 2014 (CN) 201420047035.6

(51) Int. Cl. E06B 9/307

(52) U.S. Cl. CPC E06B 9/307

(57) ABSTRACT

A blind includes a headrail, a first slat set, a second slat set, a turning module, a first ladder, and a second ladder. The turning module is provided in the headrail. The first and the second ladders are respectively connected to the turning module with an end thereof, and respectively contact the first and the second slat sets, which are arranged below the headrail in sequence. A first control cord is connected to the first slat set to spread or collapse a plurality of first slats in the first slat set; a second control cord is connected to the second slat set to spread or collapse a plurality of second slats in the second slat set. Whereby, the first and the second slat sets can be respectively spread or collapsed.

The current application claims a foreign priority to the patent application of China No. 201420047035.6 filed on Jan. 24, 2014.

### BACKGROUND OF THE INVENTION

1. Technical Field

The present invention relates generally to a covering of an opening of a building, and more particularly to a window blind.

2. Description of Related Art

Blinds are widely used to shade openings of buildings, such as windows or doors. Typically, a conventional blind includes a headrail, a bottom rail, a plurality of slats therebetween, and a control cord. The control cord is connected to the slats and the bottom rail through lift cords, and extends out of the headrail. A user can open an opening of a building from bottom toward up by operating the control cord to lift the bottom rail with the lift cords. As the bottom rail is being lifted, the slats are brought upward and collapsed one by one.

However, when the bottom rail of a conventional blind is lifted, only the part of the opening which is below the bottom rail is opened; the rest part of the opening is between the headrail and the bottom rail, and therefore is still shaded. Apparently, conventional blinds are unable to satisfy the requirement to open the upper part of an opening while keeping the lower part being shaded. In light of this, it would be preferable to have a blind capable of only collapsing slats which are not at the lower part.

### BRIEF SUMMARY OF THE INVENTION

In view of the above, the primary objective of the present invention is to provide a window blind, which can alternatively open the upper or the lower part of the opening.

The present invention provides a blind of an opening of a building, which includes a headrail, a first slat set, a second slat set, a first control cord, a second control cord, a turning module, a first ladder and a second ladder. The first slat set has a plurality of first slats, wherein the first slats are directly under the headrail. The second slat set has a plurality of second slats, wherein the second slats are directly under the first slats. The first control cord has an end extending out of the headrail and an opposite end connected to the first slats of the first slat set to be operated to lift and lower the first slats. The second control cord has an end extending out of the headrail and an opposite end connected to the second slats of the second slat set to be operated to lift and lower the second slats. The turning module is provided in the headrail. The first ladder has an end connected to the turning module, wherein the first ladder is connected to the first slats. The second ladder has an end connected to the turning module, wherein the second ladder is connected to the second slats. The first and the second ladders are movable in the same direction.

In an embodiment, the first ladder has two first vertical sections and a plurality of first horizontal sections with opposite ends connected to the first vertical sections; the first slats respectively rest on the first horizontal sections to be between the first vertical sections; the second ladder has two second vertical sections and a plurality of second horizontal sections with opposite ends connected to the second vertical sections; the second slats respectively rest on the second horizontal sections to be between the second vertical sections.

In an embodiment, the first control cord has a first lifting section connected to a bottom of the first slat set with a first end thereof; the second control cord has a second lifting section passing through the first slat set and being connected to the second slat set with a second end thereof.

In an embodiment, each of the first slats has a first perforation, and each of the second slats has a second perforation; both the first lifting section and the second lifting section pass through the first perforations of the first slats in sequence, and only the second lifting section passes through the second perforations of the second slats in sequence.

In an embodiment, each of the first slats has a first perforation, and one of the first vertical sections is provided with a plurality of first loops which are inserted into the first perforations of the first slats respectively to fasten the first vertical section to the first slats; each of the second slats has a second perforation, and one of the second vertical sections is provided with a plurality of second loops which are inserted into the second perforations of the second slats respectively to fasten the second vertical section to the second slats; the first lifting section of the first control cord passes through the first loops in sequence, and the second lifting section of the second control cord passes through the second loops in sequence.

In an embodiment, the first slat set further includes a first fixing member connected to the bottom of the first slat set; a bottom end of each of the first vertical sections is fastened to the first fixing member.

In an embodiment, the first slat set further includes a first fixing member connected to the bottom of the first slat set, and the first ends of the first lifting sections are fastened to the first fixing member.

In an embodiment, the first fixing member is provided with a recess, in which the first ends of the first vertical sections are received.

In an embodiment, the second slat set further includes a second fixing member connected to the bottom of the second slat set; a bottom end of each of the second vertical sections is fastened to the second fixing member.

In an embodiment, the second slat set further includes a second fixing member connected to the bottom of the second slat set; the second ends of the second lifting sections are fastened to the second fixing member.

In an embodiment, the second fixing member is provided with a recess, in which the second ends of the second vertical sections are received.

In an embodiment, at least one of the first vertical sections of the first ladders is provided with a plurality of rings, and the second vertical sections of the second ladders pass through the rings of the corresponding first vertical sections.

In an embodiment, the first vertical sections of the first ladder are hidden behind the second vertical sections of the second ladder.

In an embodiment, the blind further includes a shaft and a tilting module received in the headrail, wherein the turning module includes a drum, and the first ladder is connected to the drum; the shaft passes through the drum; the tilting module includes a driving member and a driven member; the driven member is connected to an end of the shaft, and meshed with the driving member; the driving member is turnable to rotate the drum through the driven member and the shaft.

In an embodiment, the tilting module further includes a wheel and at least one adjusting cord; the driving member is connected to the wheel; the driving member and the wheel share a common axis of rotation, which is vertical to an elongated direction of the headrail; the at least one adjusting cord is connected to the wheel, and extend out of the headrail through a bore.

In an embodiment, the tilting module further includes at least one sliding member; the adjusting cord is wound around the sliding member.

In an embodiment, the headrail has a front board, which has a protrusion at a bottom end thereof; the bore and the at least one sliding member are hidden behind the protrusion.

In an embodiment, the axis of rotation of the wheel is vertical to the bottom of the headrail.

In an embodiment, the blind further includes a tilting module received in the headrail, wherein the turning module includes a plurality of connecting members having ends connected to the first ladder and the second ladder respectively, while opposite ends thereof are connected to the tilting module.

In an embodiment, the tilting module further includes at least one wheel; the connecting members are wound around the wheel in opposite directions, so that the connecting members are movable in opposite directions when the wheel is turned.

Whereby, the first slat of the first slat set and second slat of the second slat set can be respectively collapsed, which improves the convenience of using a window blind.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of a first preferred embodiment of the present invention;

FIG. 2 is a partial exploded view of the first preferred embodiment of the present invention;

FIG. 3 is a partial perspective view of the first preferred embodiment of the present invention, showing the second slat and the related cords;

FIG. 4 is a partial perspective view of the first preferred embodiment of the present invention, showing the drum;

FIG. 5 is an partial exploded view of the tilting module of the first preferred embodiment of the present invention;

FIG. 6 is a partial schematic diagram of the first preferred embodiment of the present invention, showing the tilting module in the headrail;

FIG. 7 is a perspective view of the first preferred embodiment of the present invention, showing the first slat set lifted;

FIG. 8 is a partial perspective view of the first preferred embodiment of the present invention, showing an alternative implementation of the second slat and the related cords;

FIG. 9 is a perspective view of a second preferred embodiment of the present invention;

FIG. 10 is a partial perspective view of the second preferred embodiment of the present invention, showing the second vertical sections shading the first vertical sections;

FIG. 11 is a perspective view of a third preferred embodiment of the present invention;

FIG. 12 is a partial perspective view of the third preferred embodiment of the present invention, showing the first loop passing through the first perforation of the first slat;

FIG. 13 is a partial perspective view of the third preferred embodiment of the present invention, showing the second loop passing through the second perforation of the second slat;

FIG. 14 is a partial perspective view of the third preferred embodiment of the present invention, showing the first and the second vertical sections being fastened to the drum;

FIG. 15 is a perspective view of an alternative implementation of the third preferred embodiment of the present invention; and

FIG. 16 is a perspective view of an alternative implementation of the tilting module and the turning module.

### DETAILED DESCRIPTION OF THE INVENTION

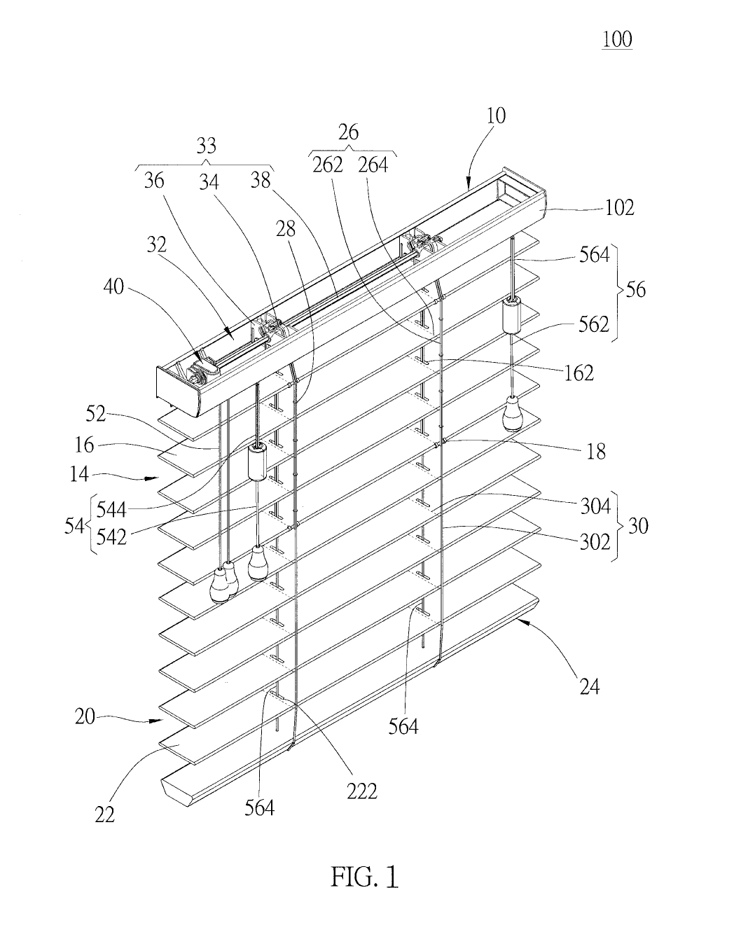

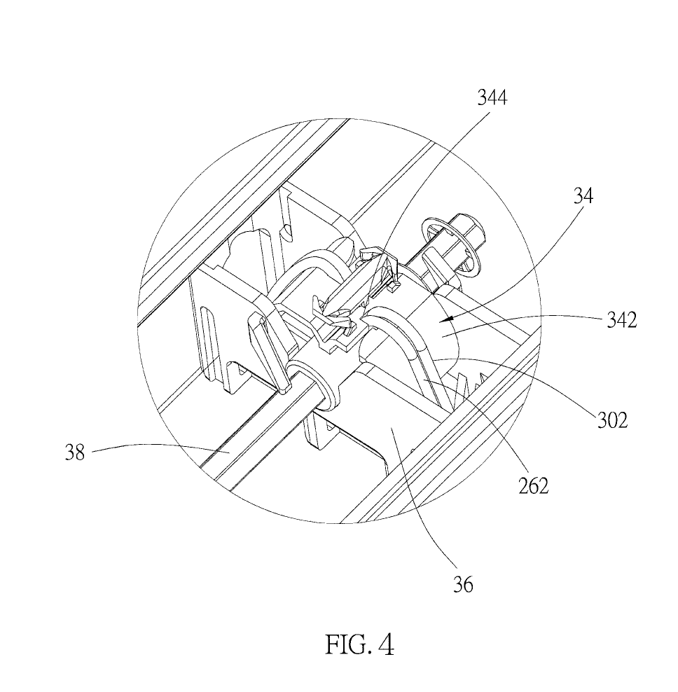

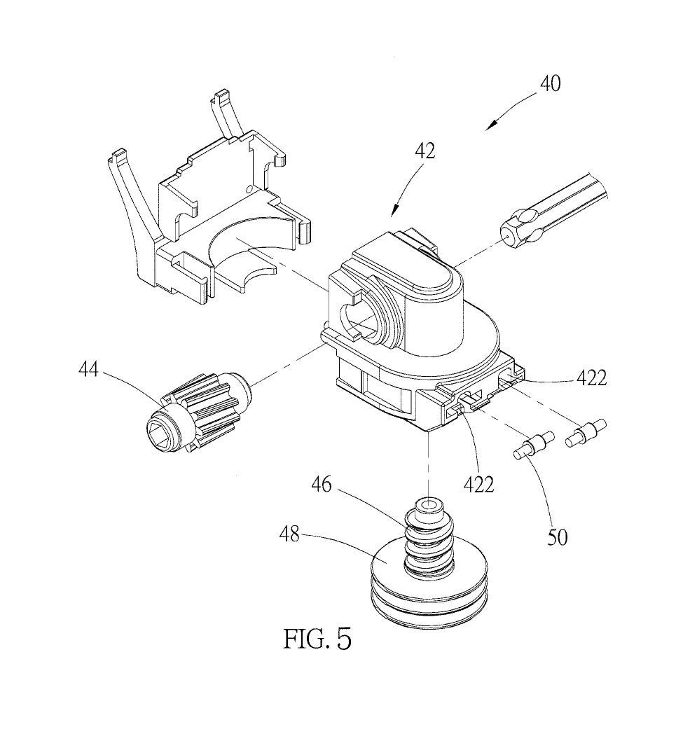

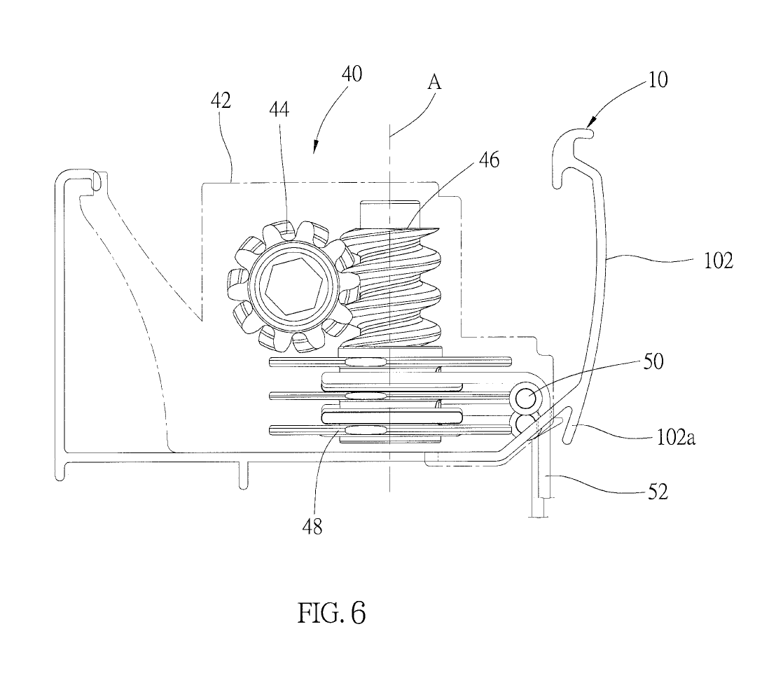

As shown in FIG. 1 to FIG. 7, a window blind 100 of the first preferred embodiment of the present invention includes a headrail 10, a first slat set 14, a second slat set 20, two first ladders 26, two second ladders 30, an angle adjusting device 32, two first control cords 54, and two second control cords 56.

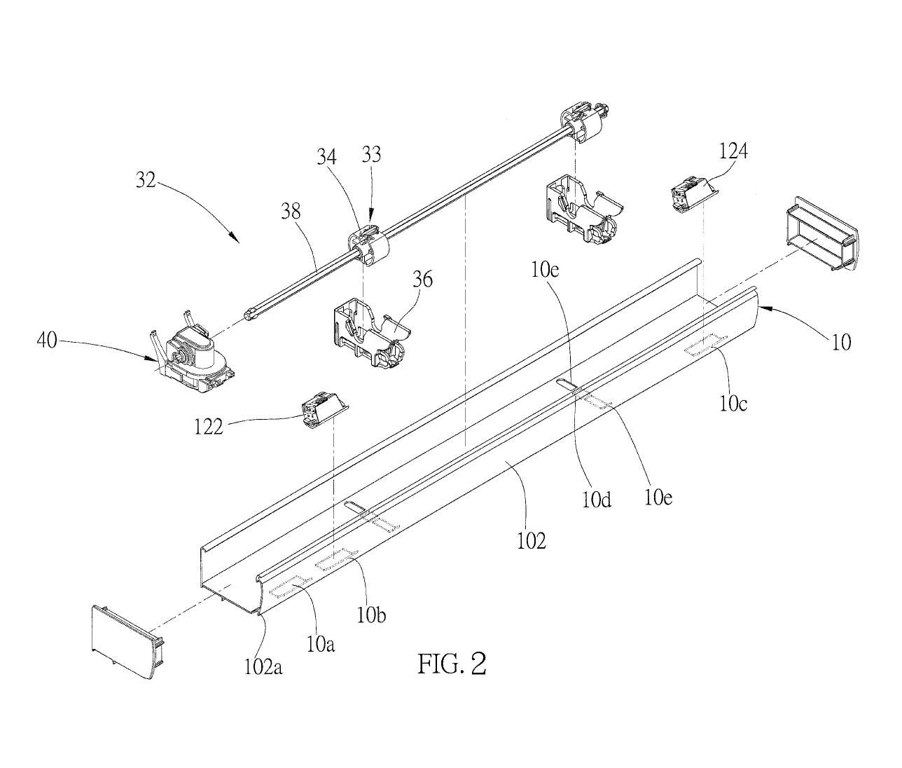

As shown in FIG. 2, the headrail 10 has a front board 102, and the front board 102 has a lower protrusion 102a at a bottom end thereof. The headrail 10 is provided with three bores 10a, 10b, 10c, two first apertures 10d, and four second apertures 10e at a bottom side thereof. Each first aperture 10d is located between two of the second apertures 10e. The lower protrusion 102a of the front board 102 is lower than the bottom side to shade the bore 10a. A first cord locker 122 and a second cord locker 124 are received in the headrail 10 in correspondence with the bores 10b and 10c respectively.

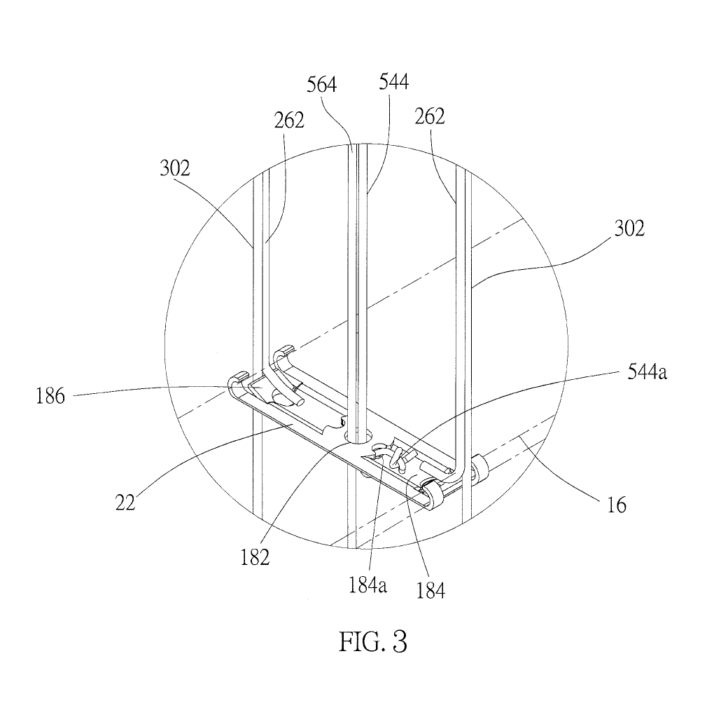

The first slat set 14 is directly under the headrail 10, and includes a plurality of first slats 16 and two first fixing members 18. Each first slat 16 has two first perforations 162, and the first fixing members 18 are connected to the lowest first slat 16 in correspondence with the first perforations 162 respectively. As shown in FIG. 3, each first fixing member 18 has a central hole 182, two first recesses 184, and two flexible portions 186. The central hole 182 is between the first recesses 184, while the flexible portions 186 are beyond the first recesses 184 respectively at opposite ends of the first fixing member 18. Each recess 184 has a hole 184a at a bottom side thereof. The first fixing member 18 further has four hooks at four corners thereof to connect the first fixing member 18 to a bottom side the lowest first slat 16. The second slat set 20 is directly under the first slat set 16, and has a plurality of second slats 22 and a bottom rail 24. Each second slat 22 is provided with two second perforations 222 aligned with the first perforations 162 of the first slats 16. The bottom rail 24 is directly under the lowest second slat 22.

Each first ladder 26 has two first vertical sections 262 and a plurality of first horizontal sections 264. The first horizontal sections 264 are equally separated, wherein each has opposite ends connected to the first vertical sections 262 respectively. In the present embodiment, the first vertical sections 262 are two cords extending out of the headrail 10 through the second apertures 10e respectively; each of the first slats 16 rests on one of the first horizontal sections 264 respectively to be in a space between the first vertical sections 262. In other words, the first vertical sections 262 contact front and rear sides of the first slats 16 respectively. A plurality of rings 28 are fitted to one of the first vertical sections 262. A bottom end of each of the first vertical sections 262 respectively enters a space between the lowest first slat 16 and one of the fixing members 18. In more details, the bottom ends of the first vertical sections 262 are respectively received in the first recesses 184, and clamped by the flexible portions 186 and the bottom side the lowest first slat 16. As a result, the first vertical sections 262 of the first ladder 26 are fixed to the fixing members 18 respectively.

Similarly, each second ladder 30 has two second vertical sections 302 and a plurality of second horizontal sections 304. The second horizontal sections 304 are equally separated, wherein each has opposite ends connected to the second vertical sections 302 respectively. In the present embodiment, the second vertical sections 302 are two cords extending out of the headrail 10 through the second apertures 10e respectively; furthermore, one of the second vertical sections 302 passes through the rings 28 to be fastened together with one of the first vertical sections 262. Each of the second slats 22 rests on one of the second horizontal sections 304 respectively to be in a space between the second vertical sections 302. In other words, the second vertical sections 302 contact front and rear sides of the first and the second slat set 14, 20 respectively. A bottom end of each of the second vertical sections 302 is fastened to the bottom rail 24. In practice, the first and the second vertical sections 262, 302 can be fabric tapes instead of cords.

As shown in FIGS. 1, 4, 5, and 6, the angle adjusting device 32 includes a turning module 33 and a tilting module 40. The turning module 33 includes two drums 34, two frames 36, and a shaft 38. The frames 36 are fixed in the headrail 10, and the drums 34 are respectively mounted on the frames 36. The drums 34 respectively correspond to the first and the second apertures 10d, 10e. Each drum 34 has a main member 342 with two grooves 344, wherein a pair of the first and the second vertical sections 262, 302 are received and secured in one of the grooves 344.

The shaft 38 passes through central holes of the drums 34. The tilting module 40 has a frame 42, on which a driven member 44, a driving member 46, a wheel 48, two sliding members 50, and two adjusting cords 52 are provided. The frame 42 is mounted in the headrail 10, and has two locking slots 422. The locking slots 422 are near the bore 10a, and higher than a bottom end of the protrusion 102a of the front board 102. The driven member 44 is a helical gear connected to an end of the shaft 38. The driving member 46 is a worm connected to the wheel 48 and meshed with the driven member 44. The driving member 46 and the wheel 48 share a common central axis A. The sliding members 50 are received in the locking slots 422 of the frame 42. In the present embodiment, the central axis A of the wheel 48 is perpendicular to an elongated direction of the bottom side of the headrail 10, and the wheel 48 is near the bottom side of the headrail 10, which effectively uses an inner space of the headrail 10, and therefore reduces the size of the headrail 10.

The adjusting cords 52 wind around the wheel 48 and the sliding member 50 in opposite directions, and then extend out of the headrail 10 through the bore 10a. The driving member 46 can be turned in either direction by pulling one of the adjusting cords 52, and therefore the drums 34 can be turned along with the driven member 44 and the shaft 38 to bring in or out the first and the second vertical sections 262, 302. If the first and the second vertical sections 262, 302 at the front side of the first slat set 14 are reeled in, the first and the second vertical sections 262, 302 at the rear side of the first slats 16 are reeled out. On the contrary, if the first and the second vertical sections 262, 302 at the front side of the first slats 16 are reeled out, the first and the second vertical sections 262, 302 at the rear side of the first slats 16 are reeled in. As a result, the first slats 16 of the first slat set 14 and the second slats 22 of the second slat set 20 can be respectively tilted with the first and the second vertical sections 262, 302. Due to the sliding members 50 are higher than the bottom end of the protrusion 102a of the headrail 10, the sliding members 50 are shaded by the protrusion 102a. In practice, the sliding members 50 can be rollers, pulleys, or round rods which are able to provide smooth operation.

In another embodiment, the tilting module 40 is simply provided with a rod (not shown) without the need of the wheel 48, the sliding members 50, and the adjusting cords 52. The rod can be turned by a user to rotate the driving member 46 in both directions, which provides the same function mentioned above. However, such structure is conventional, and therefore is not described in detail herein.

Each first control cord 54 includes a first control section 542 and two first lifting sections 544. An end of each of the first lifting sections 544 is connected to the first control section 542 together, wherein the first control section 542 is exposed to be operated. Another end of each of the first lifting sections is defined as a first end 544a, which passes through the bore 10b of the headrail 10, the first cord locker 122, one of the first apertures 10d of the headrail 10, and then the first perforations 162 of the first slats 16 in sequence. As shown in FIG. 3, the first end 544a of each of the first lifting sections 544 is inserted into the first central hole 182 of the corresponding first fixing member 18, and then goes into the first recess 184 through the hole 184a. Furthermore, the first end 544a forms a knot in the first recess 184, wherein the knot is larger than the hole 184a, but is still small enough to be completely received in the first recess 184, so that the first lifting sections 544 are fastened to the lowest first slat 16 through the first fixing member 18, and the first fixing member 18 tightly abuts against the lowest first slat 16.

Similarly, each second control cord 56 also includes a second control section 562 and two second lifting sections 564. An end of each of the second lifting sections 564 is connected to the second control section 562 together, while another end thereof is defined as a second end (not shown), which passes through the bore 10c of the headrail 10, the second cord locker 124, one of the first apertures 10d of the headrail 10, the first and the second perforations 162, 222 of the first and the second slats 16, 22 in sequence, and then the first fixing member 18 to be fastened to the bottom rail 24.

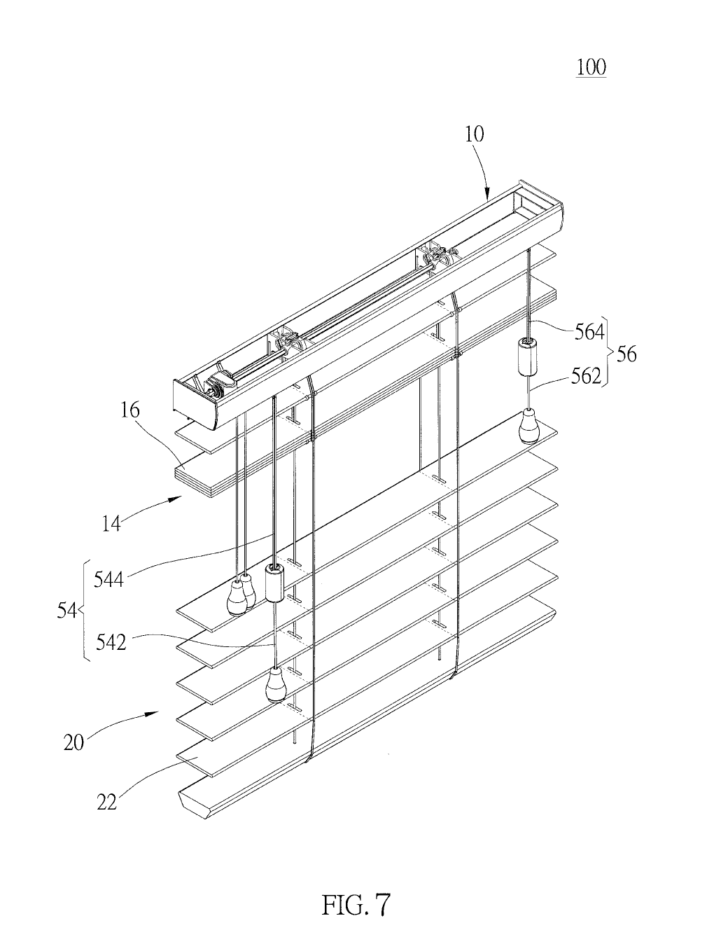

As shown in FIG. 7, a user may pulls the first control sections 542 to drive the lowest first slat 16 through the first lifting sections 544 to move upward or downward, so as to lower the first slat set 14 to an extended status (FIG. 1) or lift the first slat set 14 to a folded status (FIG. 7) The same as above, a user may pulls the second control sections 562 to drive the bottom rail 24 to move upward or downward, so as to extend or fold the second slat set 20.

In addition, if the second control section 562 of the second control cord 56 is continuously being pulled, the first slats 16 of the first slat set 14 is lifted along with the second slat set 20. With the rings 28, the second vertical sections 302 are ensured to be moved along with the first vertical sections 262 without forming a loose loop on the first slat set 14 to provide a safety operation.

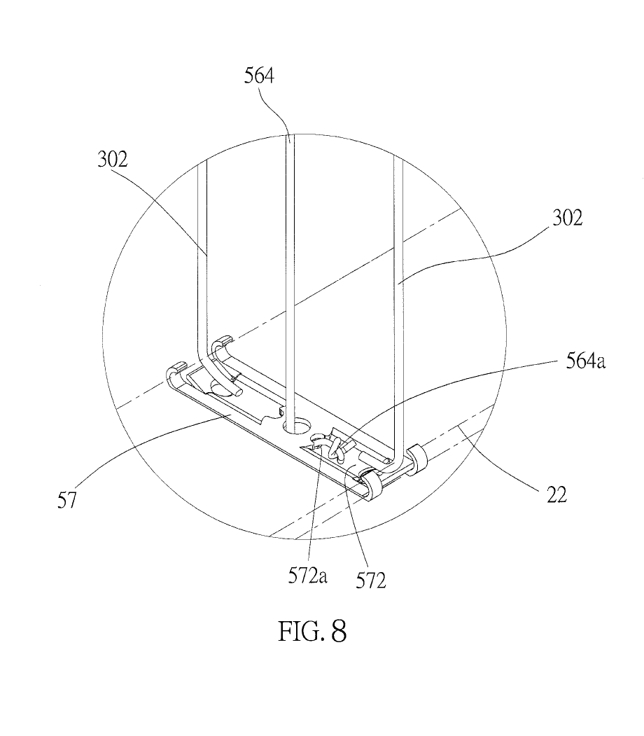

In practice, there can be two second fixing members 57 connected to the lowest second slat 22 of the second slat set 20 instead of the bottom rail 24. As shown in FIG. 8, the second fixing members 57 have the same structure with the first fixing members 18. Specifically, each of the second fixing members 57 has two recesses 572, each of which has a hole 572a at a bottom thereof. In the same way of the first fixing members 18, a knot formed by a first end 564a of each of the second lifting sections 564 is received in a second recess 572 of one of the second fixing members 57, while the end of each second vertical section 302 is held by one of the second fixing members 57 and the bottom side of the lowest second slat 22 together.

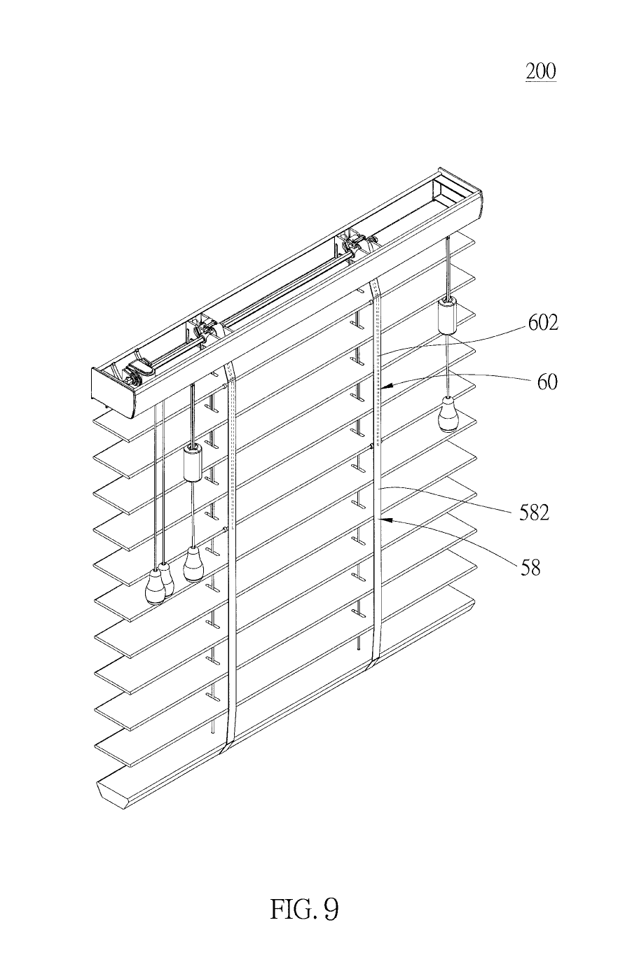

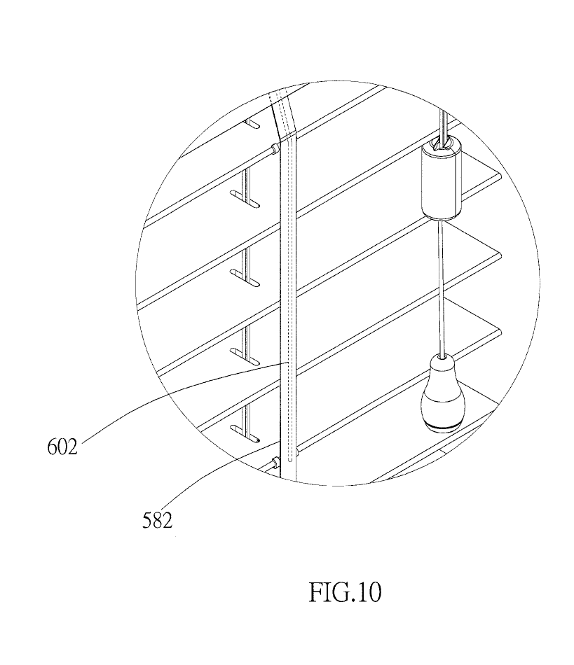

As shown in FIG. 9 and FIG. 10, a window blind 200 of the second preferred embodiment of the present invention is similar to the window blind 100 of the first preferred embodiment, except that second vertical sections 582 of a second ladder 58 are fabric tapes, and are wider than first vertical sections 602 of the first ladders 60. Each first vertical section 602 is hidden behind the corresponding second vertical section 582, therefore only the second vertical sections 582 are visible. In practice, the first vertical sections can also be fabric tapes no wider than the second vertical sections. In this way, the first vertical sections are still shaded by the second vertical sections.

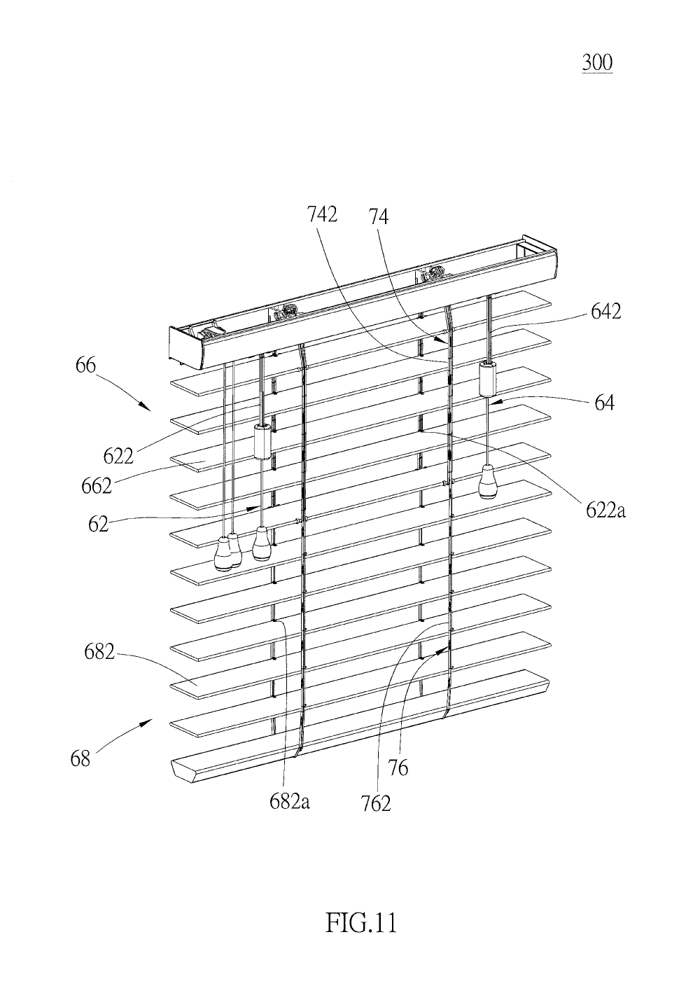

As shown in FIGS. 11 to 14, a window blind 300 of the third preferred embodiment of the present invention is also similar to the window blind 100 of first preferred embodiment, except that a first and a second control cords 62, 64 each has four lifting sections 622, 642. Two of the first lifting sections 622 of the first control cord 62 extend over one side (i.e. the front side) of first slats 662 of a first slat set 66, while the other two first lifting sections 622 extend over the opposite side (i.e., the rear side) of the first slats 662 of the first slat set 66. Similarly, two of the first lifting sections 662 of the first control cord 62 extend over the front side of the first and second slats 662, 682 of the first slat set 66 and a second slat set 68, while the other two second lifting sections 682 extend over the rear side of the first and the second slats 662, 682. Comparing to the window blinds 100, 200 of the first and the second preferred embodiments which have the lifting sections passing through the openings of the slats, the slats 662, 682 of the window blind 300 of the third preferred embodiment can be tilted at a larger angle.

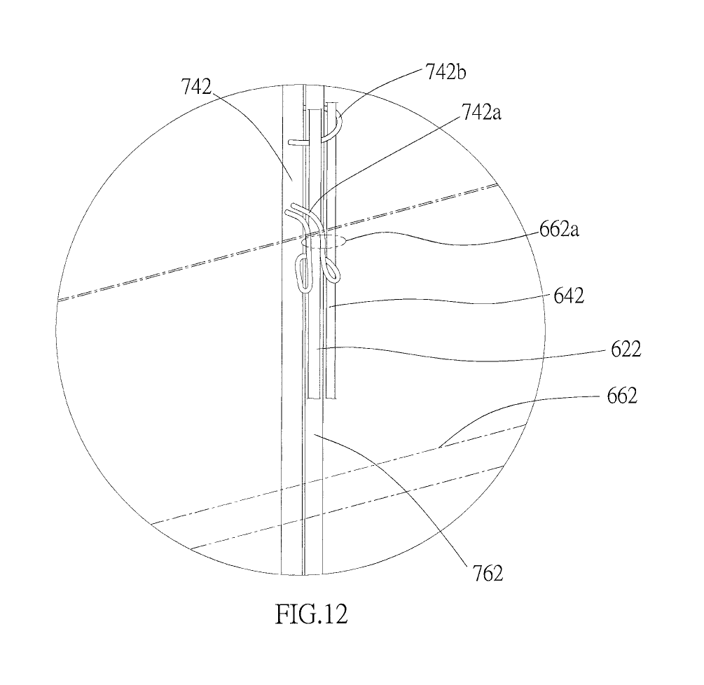

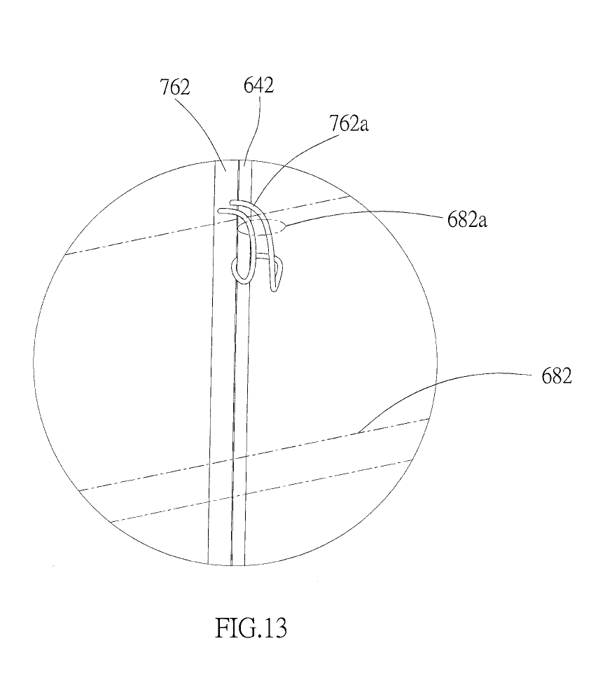

As shown in FIG. 12 and FIG. 13, each first slat 662 has two first perforations 662a respectively in correspondence with one of the first vertical sections 742 of each first ladder 74, and each second slat 682 has two second perforations 682a respectively in correspondence with one of the second vertical sections 762 of each second ladder 76. A plurality of first loops 742a and a plurality of rings 742b are provided on each first vertical section 742 of the first ladders 74, while a plurality of second loops 762a are provided on each second vertical section 762 of the second ladders 76. The first loops 742a are fastened to the corresponding first slat 662 through the first perforations 662a, and the second loops 762a are fastened to the corresponding second slats 682 through the second perforations 682a. In this way, the first and the second slats 662, 682 are tilted when the first and the second sections 742, 762 of the first and the second ladders 74, 76 are moved. The first lifting sections 622 beside the first vertical sections 742 respectively and sequentially pass through the corresponding first loops 742a which have passed through the first perforations 662a of the first slats 662. The second lifting sections 642 and the second vertical sections 762 of the second ladders 76 pass through the corresponding rings 742b on the first vertical sections 742 in sequence. Furthermore, the second vertical sections 762 beside the second lifting sections 642 respectively pass through the corresponding second loops 762a which have passed through the second perforations 682a. Whereby, the first and the second loops 742a, 762a are respectively secured to the first and the second perforations 662a, 682a of the first and the second slats 662, 682.

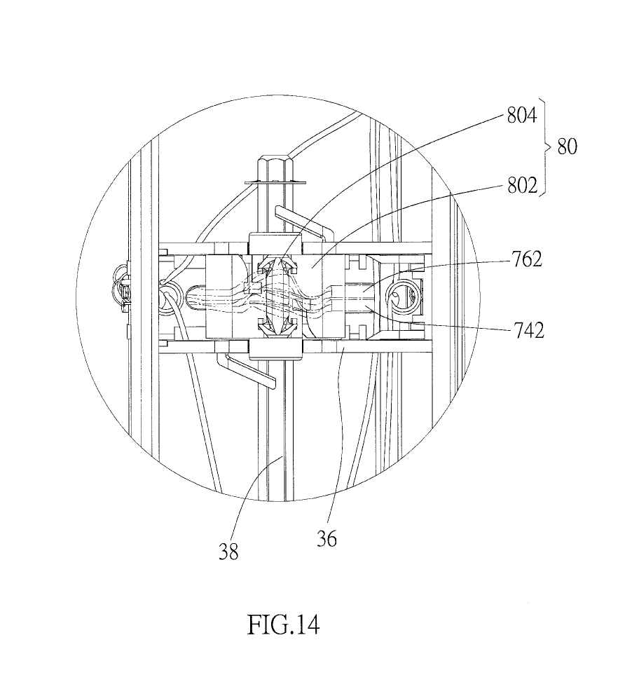

As shown in FIG. 14, a drum 80 of the third preferred embodiment includes a main member 802 and a connector 804 engaging to the main member 802. The first and the second vertical sections 742, 762 are fastened to the connector 804. The main member 802 is connected to the shaft 38 to be rotated by the shaft 38, and therefore the first and the second vertical sections 742, 762 of the first and the second ladders 74, 76 can be lifted and lowered. However, the structure of the drum 80 described herein is not a limitation of the present invention, the drum 34 of the first preferred embodiment can be used in the third preferred embodiment too.

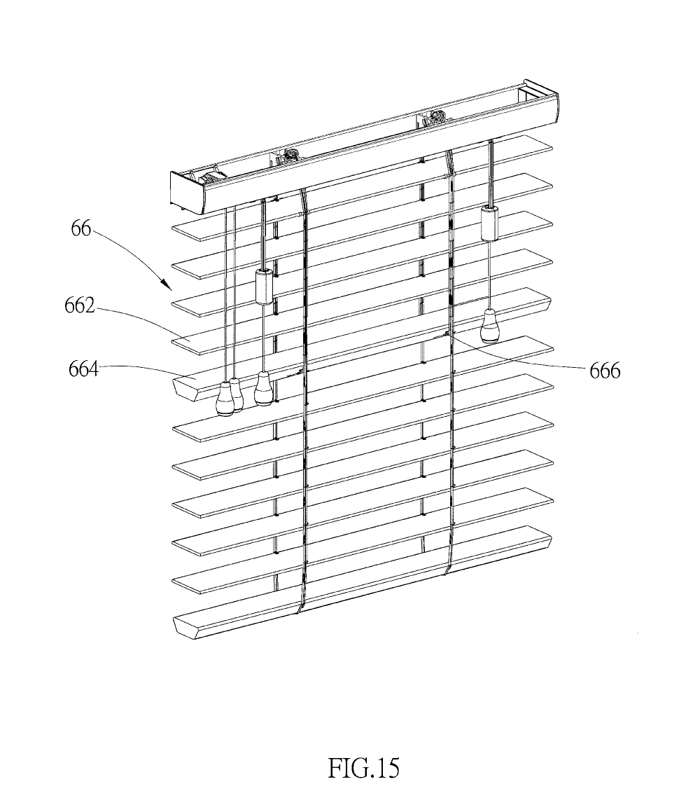

Moreover, in another embodiment shown in FIG. 15, the first slat set 66 includes the first slats 662 and a middle rail 664, which is directly under the first slats 662 and is connected to the first ladders 74 with two first fixing members 666. As a result, the first ladders 74 and the first lifting sections 622 are fastened to the first slat set 66.

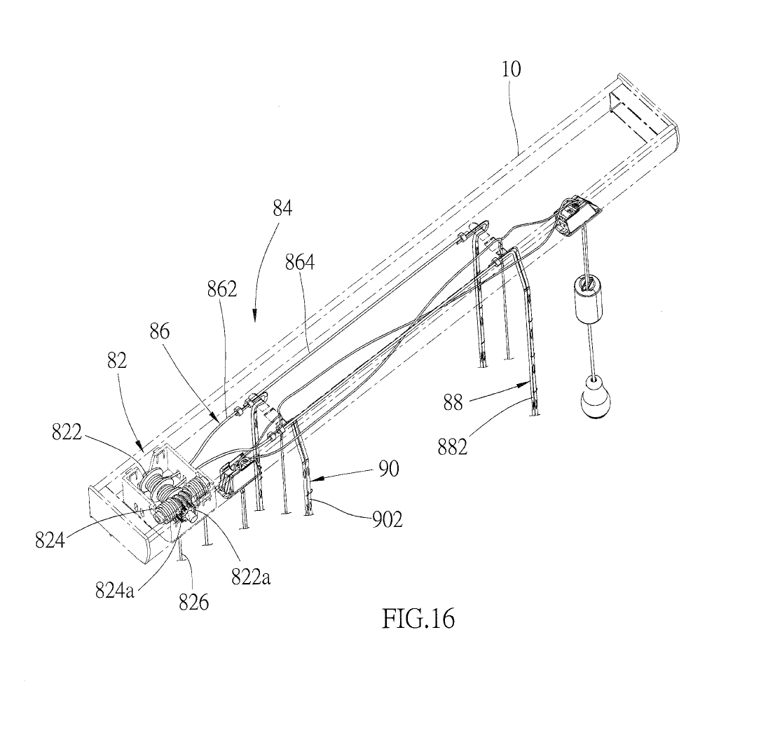

FIG. 16 shows an alternative implementation to tilt the slats with a tilting module 82 and a turning module 84.

The tilting module 82 includes a first wheel 822 and a second wheel 824, wherein the first wheel 822 is provided with a driven member 822a at an end thereof, and the second wheel 824 is provided with a driving member 824a. The driven member 822a is a helical gear, and the driving member 824a is a worm meshed with the helical gear (i.e., the driven member 822a). Two adjusting cords 826 are wound around the second wheel 824 in opposite directions.

The turning module 84 includes a plurality of connecting members 86, which are wires in the present embodiment, wherein each connecting member 86 has a first section 862 and a second section 864. The first sections 862 are wound around the first wheel 822 in opposite directions, and have ends connected to a first vertical section 882 of a first ladder 88 and a second vertical section 902 of a second ladder 90 at a location near the tilting module 82. Each of the second sections 864 is connected to two of the first vertical sections 882 at the same side and two of the second vertical sections 902.

Whereby, by using the adjusting cords 826, the driving member 824a of the second wheel 824 can be turned to move the first and the second vertical sections 882, 902 in opposite directions. In practice, the second section 864 can be wound around the first wheel 822, or, the first and the second sections 862, 864 can be made as a single element, which provides the same function of moving the first and the second vertical sections 882, 902 in opposite directions.

In conclusion, the blind of the present invention provides two independent slat sets to be controlled by two control cords. Each slat set can be independently operated to collapse an upper or lower part of the blind. It is worth mentioning that if the lifting cords of the blinds are provided at the front and the rear sides of the slats instead of passing through the perforations of the slats, it provides better shading when the slats are tilted. In addition, the loops which are used to connect the lifting cords to the slats are also helpful for the shading. Though there are two control cords, two first ladders, two second ladders, and two drums described in the drawings and description, the numbers of these components are not limitations of the present invention.

It must be pointed out that the embodiments described above are only some preferred embodiments of the present invention. All equivalent structures which employ the concepts disclosed in this specification and the appended claims should fall within the scope of the present invention.

What is claimed is:

1. A blind of an opening of a building, comprising:
a headrail;
a first slat set having a plurality of first slats, wherein the first slats are directly under the headrail;
a second slat set having a plurality of second slats, wherein the second slats are directly under the first slats;
a first control cord having an end extending out of the headrail and an opposite end connected to the first slats of the first slat set to be operated to lift and lower the first slats;
a second control cord having an end extending out of the headrail and an opposite end connected to the second slats of the second slat set to be operated to lift and lower the second slats;
a turning module provided in the headrail;
a first ladder having an end connected to the turning module, wherein the first ladder is connected to the first slats; and
a second ladder having an end connected to the turning module, wherein the second ladder is connected to the second slats;
wherein the first and the second ladders are movable in the same direction.

2. The blind of claim 1, wherein the first ladder has two first vertical sections and a plurality of first horizontal sections with opposite ends connected to the first vertical sections; the first slats respectively rest on the first horizontal sections to be between the first vertical sections; the second ladder has two second vertical sections and a plurality of second horizontal sections with opposite ends connected to the second vertical sections; the second slats respectively rest on the second horizontal sections to be between the second vertical sections.

3. The blind of claim 2, wherein the first control cord has a first lifting section connected to a bottom of the first slat set with a first end thereof; the second control cord has a second lifting section passing through the first slat set and being connected to the second slat set with a second end thereof.

4. The blind of claim 3, wherein each of the first slats has a first perforation, and each of the second slats has a second perforation; both the first lifting section and the second lifting section pass through the first perforations of the first slats in sequence, and only the second lifting section passes through the second perforations of the second slats in sequence.

5. The blind of claim 3, wherein each of the first slats has a first perforation, and one of the first vertical sections is provided with a plurality of first loops which are inserted into the first perforations of the first slats respectively to fasten the first vertical section to the first slats; each of the second slats has a second perforation, and one of the second vertical sections is provided with a plurality of second loops which are inserted into the second perforations of the second slats respectively to fasten the second vertical section to the second slats; the first lifting section of the first control cord passes through the first loops in sequence, and the second lifting section of the second control cord passes through the second loops in sequence.

6. The blind of claim 3, wherein the first slat set further includes a first fixing member connected to the bottom of the first slat set; a bottom end of each of the first vertical sections is fastened to the first fixing member.

7. The blind of claim 3, wherein the first slat set further includes a first fixing member connected to the bottom of the first slat set, and the first ends of the first lifting sections are fastened to the first fixing member.

8. The blind of claim 7, wherein the first fixing member is provided with a recess, in which the first ends of the first vertical sections are received.

9. The blind of claim 3, wherein the second slat set further includes a second fixing member connected to the bottom of the second slat set; a bottom end of each of the second vertical sections is fastened to the second fixing member.

10. The blind of claim 3, wherein the second slat set further includes a second fixing member connected to the bottom of the second slat set; the second ends of the second lifting sections are fastened to the second fixing member.

11. The blind of claim 10, wherein the second fixing member is provided with a recess, in which the second ends of the second vertical sections are received.

12. The blind of claim 2, wherein at least one of the first vertical sections of the first ladders is provided with a plurality of rings, and the second vertical sections of the second ladders pass through the rings of the corresponding first vertical sections.

13. The blind of claim 2, wherein the first vertical sections of the first ladder are hidden behind the second vertical sections of the second ladder.

14. The blind of claim 1, further comprising a shaft and a tilting module received in the headrail, wherein the turning module includes a drum, and the first ladder is connected to the drum; the shaft passes through the drum; the tilting module includes a driving member and a driven member; the driven member is connected to an end of the shaft, and meshed with the driving member; the driving member is turnable to rotate the drum through the driven member and the shaft.

15. The blind of claim 14, wherein the tilting module further includes a wheel and at least one adjusting cord; the driving member is connected to the wheel; the driving member and the wheel share a common axis of rotation, which is vertical to an elongated direction of the headrail; the at least one adjusting cord is connected to the wheel, and extend out of the headrail through a bore.

16. The blind of claim 15, wherein the tilting module further includes at least one sliding member; the adjusting cord is wound around the sliding member.

17. The blind of claim 16, wherein the headrail has a front board, which has a protrusion at a bottom end thereof; the bore and the at least one sliding member are hidden behind the protrusion.

18. The blind of claim 17, wherein the axis of rotation of the wheel is vertical to the bottom of the headrail.

19. The blind of claim 1, further comprising a tilting module received in the headrail, wherein the turning module includes a plurality of connecting members having ends connected to the first ladder and the second ladder respectively, while opposite ends thereof are connected to the tilting module.

20. The blind of claim 19, wherein the tilting module further includes at least one wheel; the connecting members are wound around the wheel in opposite directions, so that the connecting members are movable in opposite directions when the wheel is turned.
